(19) United States
(12) Patent Application Publication
(10) Pub. No.: US 2026/0264673 A1
(43) Pub. Date: Sep. 10, 2026

(54) DRIVING ASSISTANCE SYSTEM, STORAGE MEDIUM STORING DRIVING ASSISTANCE PROGRAM, AND DRIVING ASSISTANCE METHOD

(71) Applicant: J-QuAD DYNAMICS Inc., Tokyo (JP)

(72) Inventors: Masaki SHIOTA, Tokyo (JP); Manabu NAGASAKA, Tokyo (JP); Toyohito NOZAWA, Tokyo (JP); Takuto KOZAKI, Tokyo (JP)

(21) Appl. No.: 19/660,780

(22) Filed: Apr. 28, 2026

Related U.S. Application Data
(63) Continuation of application No. PCT/JP2024/033145, filed on Sep. 17, 2024.

(30) Foreign Application Priority Data
Nov. 7, 2023 (JP) 2023-190329

(51) Int. Cl. B60W 30/09; B60T 8/1755; B60W 10/18; B60W 10/20; B60W 30/095; B62D 15/02

(52) U.S. Cl. CPC B60W 30/09; B60T 8/17558; B60W 10/18; B60W 10/20; B60W 30/0956; B62D 15/0265; B60T 2201/022

(57) ABSTRACT

A driving assistance system for assisting collision avoidance with an object during driving of a host vehicle includes a processor configured to control a turn of the host vehicle to an avoidance direction for the collision avoidance before a collision risk between the host vehicle and the object increases to a collision avoidance range at which collision avoidance is required, and, in response to the collision risk reaching the collision avoidance range in the host vehicle that has been subjected to turning control in the avoidance direction, perform a coordinated control of a braking force and a steering angle applied from an actuator system to a wheel, in accordance with a driving trajectory planned for the host vehicle for the collision avoidance.

### CROSS REFERENCE TO RELATED APPLICATION

The present application is a continuation application of International Patent Application No. PCT/JP2024/033145 filed on Sep. 17, 2024 which designated the U.S. and claims the benefit of priority from Japanese Patent Application No. 2023-190329 filed on Nov. 7, 2023. The entire disclosures of all of the above applications are incorporated herein by reference.

### TECHNICAL FIELD

The present disclosure relates to a driving assistance technology for assisting collision avoidance with an object in driving of a vehicle.

### BACKGROUND

The technology disclosed in a related art controls a steering torque to be output to an actuator in order to avoid a collision with an object in a vehicle.

### SUMMARY

According to an aspect of the present disclosure, a driving assistance system for assisting collision avoidance with an object during driving of a host vehicle includes a processor configured to execute: turning control of the host vehicle toward an avoidance direction for the collision avoidance before a collision risk between the host vehicle and the object increases to a collision avoidance range at which collision avoidance is required; and in response to the collision risk reaching the collision avoidance range in the host vehicle that has been subjected to turning control toward the avoidance direction, coordinated control of a braking force and a steering angle applied to wheels by an actuator system including a braking actuator and a steering actuator, in accordance with a driving trajectory planned for the host vehicle for the collision avoidance. The turning control of the host vehicle may include turning control of the host vehicle toward the avoidance direction by limiting control to a left-right distribution of the braking force applied from the braking actuator to the wheels in the host vehicle. The coordinated control of the host vehicle may include coordinated control of the steering angle applied from the steering actuator to the wheels in the host vehicle and the braking force.

### BRIEF DESCRIPTION OF DRAWINGS

FIG. 1 is a block diagram illustrating a physical configuration of a driving assistance system according to a first embodiment.

FIG. 2 is a schematic diagram illustrating a driving environment of a host vehicle to which the first embodiment is applied.

FIG. 3 is a block diagram illustrating a functional configuration of the driving assistance system according to the first embodiment.

FIG. 4 is a flowchart illustrating a driving assistance flow according to the first embodiment.

FIG. 5 is a graph for explaining the driving assistance flow according to the first embodiment.

FIG. 6 is a flowchart illustrating a driving assistance flow according to a second embodiment.

FIG. 7 is a graph for explaining the driving assistance flow according to the second embodiment.

FIG. 8 is a flowchart illustrating a driving assistance flow according to a third embodiment.

FIG. 9 is a graph for explaining the driving assistance flow according to the third embodiment.

### DETAILED DESCRIPTION

In the technology disclosed in a related art, a target steering angle is merely set in accordance with a lateral movement amount on a driving trajectory required for predicted collision avoidance even during deceleration of the vehicle by braking. As a result, if the steering torque for providing the target steering angle tailored to the lateral movement amount is controlled to a high level by a correction gain, there may be a concern about lateral movement deficiency caused by a response delay of the steering angle in the actuator. This hinders accurate tracing of the vehicle with respect to the driving trajectory toward collision avoidance, and thus there may be a need for improvement in securing a margin for collision avoidance from the viewpoint of safety and security.

The present disclosure provides a driving assistance system effective for collision avoidance with an object in a vehicle. The present disclosure provides a driving assistance program effective for collision avoidance with an object in a vehicle. The present disclosure provides a driving assistance method effective for collision avoidance with an object in a vehicle.

According to one aspect of the present disclosure, a driving assistance system for assisting collision avoidance with an object during driving of a host vehicle includes a processor configured to execute: turning control of the host vehicle toward an avoidance direction for the collision avoidance before a collision risk between the host vehicle and the object increases to a collision avoidance range at which collision avoidance is required; and in response to the collision risk reaching the collision avoidance range in the host vehicle that has been subjected to turning control toward the avoidance direction, coordinated control of a braking force and a steering angle applied to wheels by an actuator system including a braking actuator and a steering actuator, in accordance with a driving trajectory planned for the host vehicle for the collision avoidance. The turning control of the host vehicle includes turning control of the host vehicle toward the avoidance direction by limiting control to a left-right distribution of the braking force applied from the braking actuator to the wheels in the host vehicle. The coordinated control of the host vehicle includes coordinated control of the steering angle applied from the steering actuator to the wheels in the host vehicle and the braking force.

According to one aspect of the present disclosure, a non-transitory computer readable storage medium stores a driving assistance program for assisting, during driving of a host vehicle, collision avoidance with an object. The driving assistance program includes instructions for causing a processor to execute: turning control of the host vehicle toward an avoidance direction for the collision avoidance before a collision risk between the host vehicle and the object increases to a collision avoidance range at which collision avoidance is required; and in response to the collision risk reaching the collision avoidance range in the host vehicle that has been subjected to turning control toward the avoidance direction, coordinated control of a braking force and a steering angle applied to wheels by an actuator system, in accordance with a driving trajectory planned for the host vehicle for the collision avoidance. The turning control of the host vehicle includes turning control of the host vehicle toward the avoidance direction by limiting control to a left-right distribution of the braking force applied from a braking actuator to the wheels in the host vehicle. The coordinated control of the host vehicle includes coordinated control of the steering angle applied from a steering actuator to the wheels in the host vehicle and the braking force.

According to one aspect of the present disclosure, a driving assistance method is executed by a processor to assist, during driving of a host vehicle, collision avoidance with an object. The driving assistance method includes: turning control of the host vehicle toward an avoidance direction for the collision avoidance before a collision risk between the host vehicle and the object increases to a collision avoidance range at which collision avoidance is required; and in response to the collision risk reaching the collision avoidance range in the host vehicle that has been subjected to turning control toward the avoidance direction, coordinated control of a braking force and a steering angle applied to wheels by an actuator system, in accordance with a driving trajectory planned for the host vehicle for the collision avoidance. The turning control of the host vehicle includes turning control of the host vehicle toward the avoidance direction by limiting control to a left-right distribution of the braking force applied from a braking actuator to the wheels in the host vehicle. The coordinated control of the host vehicle includes coordinated control of the steering angle applied from a steering actuator to the wheels in the host vehicle and the braking force.

According to these aspects, the turning control of the host vehicle is performed in the avoidance direction toward collision avoidance before the collision risk of the host vehicle with the object rises to the collision avoidance range requiring collision avoidance for the host vehicle. As a result, in response to the collision risk reaching the collision avoidance range in the host vehicle controlled to turn in the avoidance direction, the braking force and the steering angle applied from the actuator system to the wheels are controlled in a coordinated manner in accordance with the driving trajectory planned for the host vehicle toward collision avoidance. With this configuration, even if a response delay of the braking force and/or the steering angle occurs in the actuator system, insufficient lateral displacement of the host vehicle can be mitigated by the turning control being executed during a period with a lower risk than the collision avoidance range. Therefore, it is possible to cause the host vehicle to accurately trace the driving trajectory and secure a margin for collision avoidance from the viewpoint of safety and security, thereby making it possible to realize driving assistance effective for collision avoidance between the object and the host vehicle.

Hereinafter, a plurality of embodiments of the present disclosure will be described based on the drawings. In each embodiment, components corresponding to each other may be denoted by the same reference numerals, and overlapping descriptions may be omitted. In addition, when only a part of a configuration is described in each embodiment, the configuration of another embodiment described previously can be applied to other parts of the configuration. Furthermore, not only combinations of configurations explicitly indicated in the description of each embodiment, but also configurations of a plurality of embodiments can be partially combined if there is no particular hindrance to the combination even if not explicitly indicated.

### First Embodiment

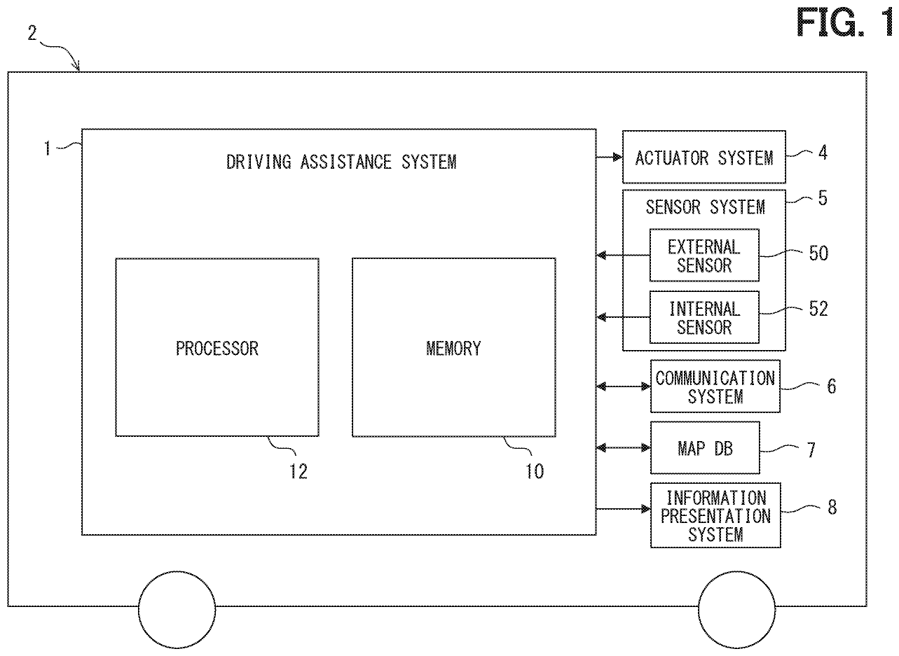

A driving assistance system 1 of a first embodiment illustrated in FIG. 1 assists driving of a host vehicle 2. At least a part of the driving assistance system 1 is mounted on the host vehicle 2. The host vehicle 2 to which the driving assistance system 1 is applied preferably realizes, for example, a level where a manual driving assistance task for assisting a manual driving operation of an operator exists together with an automated driving task among automated driving levels defined in SAE J3016 or the like. Such a host vehicle 2 is a road user such as an automobile or a truck, and may be referred to as an ego-vehicle. Accordingly, the driving assistance system 1 is configured to provide driving assistance to a driver who rides in the host vehicle 2 and is capable of performing manual driving operations as the operator of the host vehicle 2.

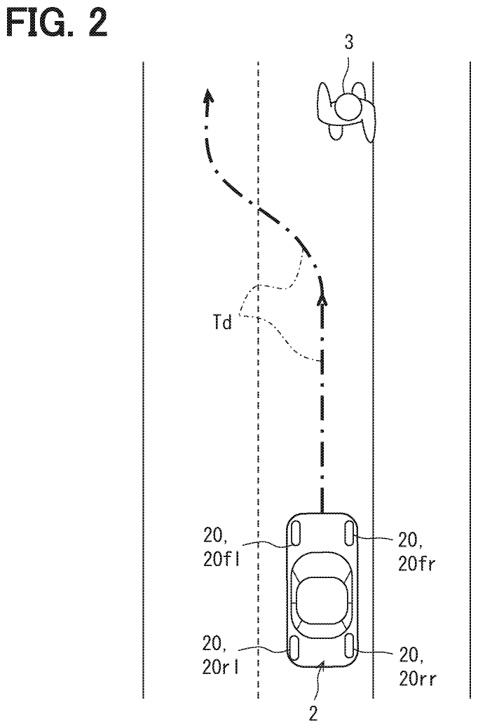

As illustrated in FIG. 2, in a driving environment where the host vehicle 2 travels, at least one type of object 3 other than the host vehicle 2 exists, such as other road users, obstacles, and structures. The other road users include non-vulnerable road users and vulnerable road users. The non-vulnerable road users are at least one type of mobile object occupied by a human, such as automobiles, trucks, motorcycles, and bicycles. The vulnerable road users are, for example, pedestrians. The obstacles include at least one of, for example, construction signs, work signs, and fallen objects. The structures include at least one of, for example, buildings, road structures, traffic lights, and road signs.

As illustrated in FIG. 1, an actuator system 4, a sensor system 5, a communication system 6, a map database (DB) 7, and an information presentation system 8 are mounted on the host vehicle 2 together with at least a part of the driving assistance system 1. However, FIG. 1 representatively illustrates an example in which the entirety of the driving assistance system 1 implemented in the form of a processing circuit (for example, a processing ECU) or a semiconductor device (for example, a semiconductor chip) is mounted on the host vehicle 2.

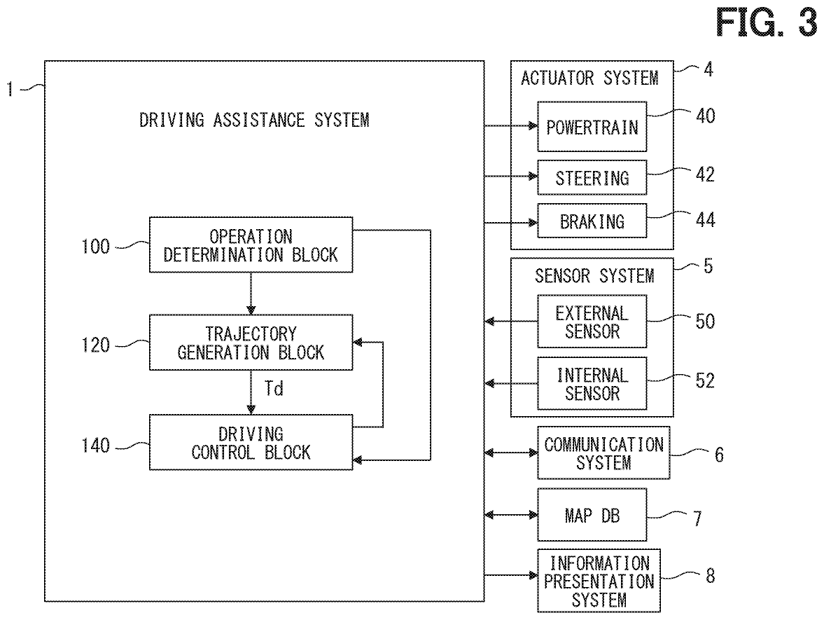

The actuator system 4 is configured to be capable of controlling the driving behavior of the host vehicle 2 based on a control command from the driving assistance system 1. As illustrated in FIG. 3, the actuator system 4 includes at least one type of powertrain actuator 40 such as an internal combustion engine and a motor generator motor. The actuator system 4 includes at least one type of steering actuator 42 such as a power steering unit. The actuator system 4 includes at least one type of braking actuator 44 such as a brake unit.

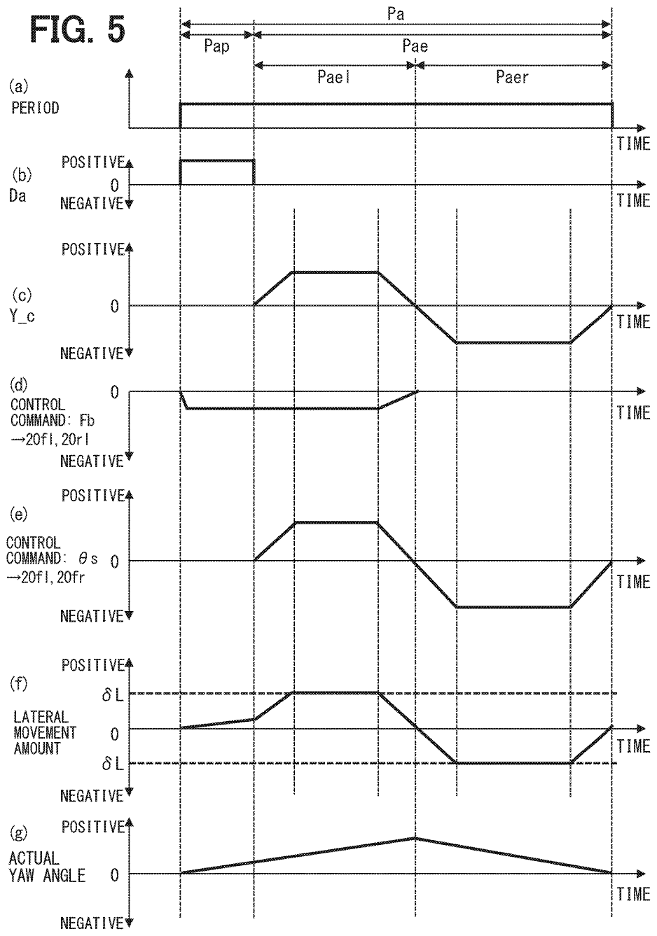

Here, as illustrated in FIG. 2, the plurality of wheels 20 of the host vehicle 2 includes front wheels 20fl and 20fr and rear wheels 20rl and 20rr. Therefore, the braking actuator 44 independently adjusts the braking force Fb (see FIG. 5 described later) applied to each of the front wheels 20fl and 20fr and each of the rear wheels 20rl and 20rr. This enables control of a left-right distribution and a front-rear distribution of the braking force Fb in the host vehicle 2.

On the other hand, the steering actuator 42 adjusts at least one of a common steering angle θs for the front wheels 20fl, 20fr and a common steering angle θs for the rear wheels 20rl, 20rr as a steering angle (see FIG. 5 described later) to be applied to the host vehicle 2. Thus, particularly in the first embodiment, in the host vehicle 2 where the common steering angle θs of the front wheels 20fl, 20fr and the common steering angle θs of the rear wheels 20rl, 20rr are adjusted mutually independently, the front-rear distribution of these common steering angles can be controlled.

As illustrated in FIG. 1, the sensor system 5 acquires sensing information available in the driving assistance system 1 by sensing an external environment and an internal environment of the host vehicle 2. For that purpose, the sensor system 5 includes an external sensor 50 and an internal sensor 52.

The external sensor 50 senses the object 3 existing outside the host vehicle 2. The object sensing type external sensor 50 is at least one of, for example, an image sensor (i.e., an in-vehicle camera), a LiDAR (light detection and ranging/laser imaging detection and ranging), a laser sensor, a millimeter wave sensor, and a sonar sensor. The object sensing type external sensor 50 is preferably implemented by combining a plurality of types so as to be capable of sensing the front, sides, and rear of the host vehicle 2.

The internal sensor 52 senses specific physical quantities related to vehicle motion in the interior of the host vehicle 2. The motion sensing type internal sensor 52 is at least one of, for example, a speed sensor, an acceleration sensor, and a gyro sensor. The internal sensor 52 may sense an operation or a state of an occupant, including the driver, riding in the host vehicle 2. The occupant sensing type internal sensor 52 is at least one of, for example, an accelerator pedal sensor, a steering angle sensor, a steering torque sensor, a brake pedal sensor, a shift sensor, an occupant camera, a steering switch, a biometric sensor, a seating sensor, and an in-vehicle device switch.

The communication system 6 acquires communication information available in the driving assistance system 1 by wireless communication. The communication system 6 may receive a positioning signal from an artificial satellite of a GNSS (global navigation satellite system) existing outside the host vehicle 2. The positioning type communication system 6 is, for example, a GNSS receiver. The communication system 6 may transmit and receive a communication signal to and from a V2X system existing outside the host vehicle 2. The V2X communication type communication system 6 is at least one of, for example, a DSRC (dedicated short range communications) transceiver and a cellular V2X (C-V2X) transceiver. The communication system 6 may transmit and receive a communication signal to and from a mobile terminal existing in the interior of the host vehicle 2. The terminal communication type communication system 6 is at least one of, for example, a Bluetooth (registered trademark) device, a Wi-Fi (registered trademark) device, and an infrared communication device.

The map DB 7 stores map information available in the driving assistance system 1. The map DB 7 includes at least one non-transitory tangible storage medium selected from, for example, a semiconductor memory, a magnetic medium, and an optical medium. The map DB 7 may be a database for a locator that estimates the self-position of the host vehicle 2. The map DB 7 may be a database of a navigation unit navigating a travel route of the host vehicle 2. The map DB 7 may be constructed by a combination of a plurality of types of databases.

The map DB 7 acquires and stores the latest map information by, for example, V2X communication with an external center via the communication system 6. The map information is stored as two-dimensional or three-dimensional data representing the external environment in which the host vehicle 2 travels. As the three-dimensional map information, digital data of a high-definition map may be employed. The map information includes road information representing at least one of, for example, a position of a road structure, a shape of the road structure, and a road surface condition. The map information may include structure information representing at least one of, for example, a position and/or a shape of a building and a traffic light facing the road. The map information may include marking information representing at least one of, for example, a position and/or a shape of a sign and a lane marking associated with the road.

The information presentation system 8 presents notification information to occupants including the driver of the host vehicle 2. The information presentation system 8 presents the notification information by stimulating the vision of the occupant in the host vehicle 2. The visual information presentation type information presentation system 8 is at least one of, for example, an in-vehicle monitor, a HUD (head-up display), a combination meter, a navigation unit, and an illumination unit. The information presentation system 8 may present the notification information by stimulating the hearing of the occupant. The auditory information presentation type information presentation system 8 is at least one of, for example, a speaker, a buzzer, and a vibration unit. The information presentation system 8 may present the notification information by stimulating the tactile sensation of the occupant. The tactile information presentation type information presentation system 8 is at least one of, for example, a vibration unit, a reaction force unit, and an air conditioning unit.

The driving assistance system 1 is connected to the actuator system 4, the sensor system 5, the communication system 6, the map DB 7, and the information presentation system 8 via at least one of, for example, a LAN (local area network), a wire harness, an internal bus, and a wireless communication line. The driving assistance system 1 includes at least one dedicated computer.

The dedicated computer constituting the driving assistance system 1 may be an integrated ECU (electronic control unit) that integrates driving control of the host vehicle 2. The dedicated computer constituting the driving assistance system 1 may be a sensing ECU processing sensing information in the driving control of the host vehicle 2. The dedicated computer constituting the driving assistance system 1 may be a recognition ECU that recognizes the external environment in the driving control of the host vehicle 2. The dedicated computer constituting the driving assistance system 1 may be a locator ECU estimating the self-position of the host vehicle 2.

The dedicated computer constituting the driving assistance system 1 may be a planning ECU that plans driving control of the host vehicle 2. The dedicated computer constituting the driving assistance system 1 may be a navigation ECU navigating a travel route in the driving control of the host vehicle 2. The dedicated computer constituting the driving assistance system 1 may be an actuator ECU controlling the actuator system 4 as the driving control of the host vehicle 2.

The dedicated computer constituting the driving assistance system 1 may be an information management ECU controlling the information presentation system 8 as the driving control of the host vehicle 2. The dedicated computer constituting the driving assistance system 1 may be at least one external computer implemented as, for example, an external center or a mobile terminal capable of communicating via the communication system 6.

The dedicated computer constituting the driving assistance system 1 includes at least one memory 10 and at least one processor 12. The memory 10 is at least one type of a non-transitory tangible storage medium that non-temporarily stores programs and data readable by the computer, among, for example, a semiconductor memory, a magnetic medium, and an optical medium. The processor 12 includes, as at least one core, at least one selected from, for example, a CPU (central processing unit), a GPU (graphics processing unit), and a RISC (reduced instruction set computer)—CPU.

The processor 12 executes a plurality of instructions included in a driving assistance program stored in the memory 10 as software. Thereby, the driving assistance system 1 constructs a plurality of functional blocks for executing driving assistance processing of the host vehicle 2. The plurality of functional blocks constructed by the driving assistance system 1 in this manner include an operation determination block 100, a trajectory generation block 120, and a driving control block 140 illustrated in FIG. 3.

The operation determination block 100 acquires sensing information from the sensor system 5. The operation determination block 100 generates operation data by determining a manual driving operation of the driver with respect to the host vehicle 2 based on the acquired sensing information. The operation data regarding the manual driving operation may represent at least one type of operation parameter corresponding to the driver operation among, for example, an accelerator pedal operation amount, a steering operation angle, a steering operation torque, a brake pedal operation amount, and a shift operation position.

The trajectory generation block 120 acquires sensing information from the sensor system 5. The trajectory generation block 120 acquires communication information from the communication system 6. The trajectory generation block 120 acquires map information from the map DB 7. The trajectory generation block 120 acquires data of past control commands to the host vehicle 2 from the driving control block 140. The trajectory generation block 120 processes these acquired pieces of information and data individually and then fuses them to generate recognition data representing the recognized external environment and internal environment of the host vehicle 2. The recognition data generated by the trajectory generation block 120 in this way represents states of the external environment and the internal environment recognized for each driving scene where the host vehicle 2 travels.

Specifically, the trajectory generation block 120 preferably generates recognition data by localization for recognizing a self-state of the host vehicle 2. The recognition data regarding the self-state may represent at least one type of motion physical quantity (may be referred to as physical quantity related to motion) among, for example, position, velocity, acceleration, jerk, yaw rate, and yaw angle, that are realized in the host vehicle 2 in accordance with a control command issued by the driving control block 140 described later. The trajectory generation block 120 preferably generates recognition data by recognizing the object 3 existing outside the host vehicle 2. The recognition data regarding the object 3 may represent at least one type of motion physical quantity among, for example, separation distance, motion direction, relative velocity, relative acceleration, and collision time margin (time to collision: TTC) with the host vehicle 2.

The trajectory generation block 120 plans a driving trajectory Td (see FIG. 2) to be a target in future driving of the host vehicle 2 based on the generated recognition data. The driving trajectory Td defines a time-series change for each control cycle assumed in the future ahead of the present time regarding a motion parameter to be a target as the self-state of the host vehicle 2. Specifically, the driving trajectory Td preferably represents position coordinates for each control cycle along a path to be traveled by the host vehicle 2 in the future. Further, the driving trajectory Td preferably represents at least one type of motion physical quantity among, for example, velocity, acceleration, jerk, yaw rate, and yaw angle as a motion parameter to be realized for each control cycle on such a locus.

The driving control block 140 acquires operation data from the operation determination block 100. The driving control block 140 acquires data of the driving trajectory Td together with the recognition data from the trajectory generation block 120. The driving control block 140 acquires data of past control commands to the host vehicle 2 by reading from the memory 10. The driving control block 140 generates a control command for controlling the driving behavior of the host vehicle 2 based on these acquired data. At this time, a control command to be sent to the actuator system 4 is generated to control, in accordance with an automated driving level adjusted to the driving scene, a driving task selected from an automated driving task and a manual driving assistance task. The control command generated in this way is stored in the memory 10.

Examples of the driving task corresponding to the automated driving level include adaptive cruise control (ACC), collision damage mitigation braking (autonomous emergency braking: AEB), and lane keeping assist (LKA). Therefore, the adjustment of the automated driving level preferably includes a takeover in which the driving task is transferred between the driving assistance system 1 and the driver by transition of a driving mode between the automated driving task and the manual driving assistance task. Such a takeover is realized at at least one type of timing among, for example, timing of a transfer request from the driver, an entry/exit timing for an operational design domain (ODD) of automated driving, and a necessary timing for a minimum risk maneuver (MRM).

### Driving Assistance Flow

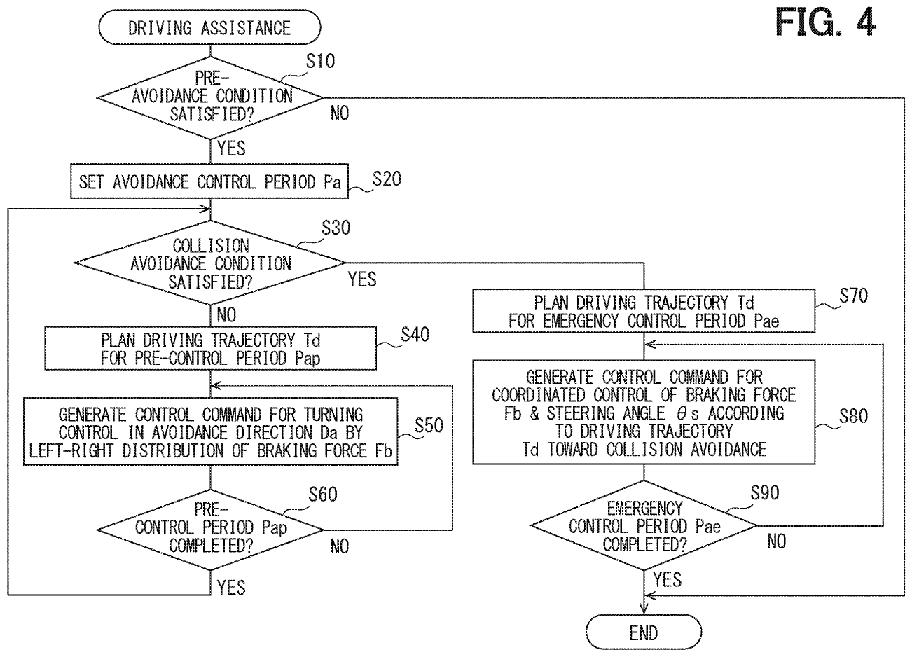

In the first embodiment, a driving assistance flow for realizing a driving assistance method for assisting driving of the host vehicle 2 is repeatedly executed according to FIG. 4 by the cooperation of the plurality of blocks 100, 120, and 140. In the following description, each “S” in the driving assistance flow denotes a step executed by one or more instructions included in the driving assistance program.

In S10 illustrated in FIG. 4, the trajectory generation block 120 determines whether a pre-avoidance condition requiring prior preparation for collision avoidance with the object 3 in the future driving of the host vehicle 2 is satisfied. The pre-avoidance condition is satisfied by reaching a pre-avoidance range lower than a collision avoidance range requiring collision avoidance for the host vehicle 2 before a collision risk of the host vehicle 2 with the object 3 rises to the collision avoidance range. Therefore, the arrival of the collision risk at the pre-avoidance range is determined based on the recognition data generated by the trajectory generation block 120. At this time, it may be determined that the collision risk has reached the pre-avoidance range when TTC becomes equal to or less than a pre-threshold time (for example, 2.3 seconds) or less than the pre-threshold time.

In S10, when a negative determination is made due to non-satisfaction of the pre-avoidance condition, the current driving assistance flow ends. On the other hand, in S10, when an affirmative determination is made due to satisfaction of the pre-avoidance condition, the current driving assistance flow proceeds to S20. In S20, the trajectory generation block 120 sets an avoidance control period Pa as illustrated in FIG. 5 in order to execute control of the host vehicle 2 toward collision avoidance.

In S30 illustrated in FIG. 4, the trajectory generation block 120 determines whether or not a collision avoidance condition requiring collision avoidance with the object 3 in the future driving of the host vehicle 2 is satisfied. The collision avoidance condition is satisfied by the collision risk of the host vehicle 2 with the object 3 exceeding the pre-avoidance range of S10 and rising to the collision avoidance range requiring collision avoidance for the host vehicle 2. Therefore, the arrival of the collision risk at the collision avoidance range is determined based on the recognition data generated by the trajectory generation block 120. At this time, it may be determined that the collision risk has reached the collision avoidance range when TTC becomes equal to or less than a threshold time (for example, 2.0 seconds) or less than the threshold time. It may be determined that the collision risk has reached the collision avoidance range when, in addition to the TTC requirement, a probability that collision avoidance is necessary due to, for example, a lane change becomes equal to or greater than a threshold value or exceeds the threshold value.

In S30, when a negative determination is made due to non-satisfaction of the collision avoidance condition, the current driving assistance flow sequentially transitions to S40, S50, and S60. That is, the sequential transition from S30 to S40, S50, and S60 is performed in response to the collision risk with the object 3 in the host vehicle 2 reaching the pre-avoidance range lower than the collision avoidance range.

In S40, the trajectory generation block 120 plans a driving trajectory Td to be followed by the host vehicle 2 over a pre-control period Pap before satisfaction of the collision avoidance condition within the avoidance control period Pa illustrated in FIG. 5, in preparation for collision avoidance with the object 3 in the future driving of the host vehicle 2. At this time, the driving trajectory Td is planned so as to define a time-series change in a required yaw rate Y_c for each control cycle in addition to a trajectory defined as time-series position coordinates, as a motion parameter to be a target in the future driving of the host vehicle 2. However, in the pre-control period Pap, the required yaw rate Y_c is planned to be a substantially 0 value as shown in FIG. 5. The sign of the required yaw rate Y_c in FIG. 5 is defined such that the counterclockwise direction around the yaw axis in the host vehicle 2 in a top view is positive and the clockwise direction is negative, however, an inverse relationship definition is also acceptable.

In S50 illustrated in FIG. 4, the driving control block 140 generates a control command to the actuator system 4 so as to perform turning control (yawing control) of the host vehicle 2 toward an avoidance direction Da for collision avoidance. At this time, the avoidance direction Da is preferably set to one of a left turning direction and a right turning direction around the yaw axis from the longitudinal axis in the host vehicle 2, following the driving trajectory Td planned in S40. However, a driving scene where determination of the avoidance direction Da from the planned driving trajectory Td is difficult or impossible is assumed. In such an assumed scene, a prediction probability of the avoidance direction Da in future driving is acquired based on at least one of the recognition data from the trajectory generation block 120 and the driving trajectory Td, whereby the avoidance direction Da with a large prediction probability is preferably selected.

In S50, the driving control block 140 of the first embodiment generates a control command for controlling the vehicle attitude of the host vehicle 2 to the avoidance direction Da by a left-right distribution of the braking force Fb to be applied to each wheel 20 of the host vehicle 2, to the braking actuator 44. At this time, the control command controls the left-right distribution of the braking force Fb for the front wheels 20fl, 20fr and the left-right distribution of the braking force Fb for the rear wheels 20rl, 20rr so that a turn in the avoidance direction Da can be realized with a slight actual yaw rate. The sign of the braking force Fb in FIG. 5 is defined such that the backward direction of the host vehicle 2 is negative, however, the sign convention may be defined such that the backward direction is positive.

Specifically, as illustrated in the pre-control period Pap of FIG. 5, when the avoidance direction Da is the left turning direction, a control command is generated so as to apply the braking force Fb to the left front wheel 20fl and the left rear wheel 20rl which are on the inner wheel side of the host vehicle 2 with a magnitude that keeps the difference between the substantially zero required yaw rate Y_c and the actual yaw rate produced by the control command within a very small allowable range. At this time, when the driver is in an override state due to a manual driving operation with respect to the host vehicle 2, based on the operation data from the operation determination block 100, the respective braking forces Fb to the left front wheel 20fl and the left rear wheel 20rl may be corrected within a range of such an allowable range difference. Furthermore, when the avoidance direction Da is the left turning direction, a control command is generated so as to apply the braking force Fb to the right front wheel 20fr and the right rear wheel 20rr which are on the outer wheel side of the host vehicle 2 with a magnitude of substantially 0.

In a case where the avoidance direction Da is the right turning direction, a control command is generated according to the case of the left turning direction so as to apply the braking force Fb to the right front wheel 20fr and the right rear wheel 20rr which are on the inner wheel side of the host vehicle 2 with a magnitude that keeps a difference between the required yaw rate Y_c of substantially 0 and the actual yaw rate produced by the control command within a very small allowable range. At this time, when the driver is in an override state due to a manual driving operation with respect to the host vehicle 2, based on the operation data from the operation determination block 100, the respective braking forces Fb to the right front wheel 20fr and the right rear wheel 20rr may be corrected within a range of such an allowable range difference. Furthermore, when the avoidance direction Da is the right turning direction, a control command is generated according to the case of the left turning direction so as to apply the braking force Fb to the left front wheel 20fl and the left rear wheel 20rl which are on the outer wheel side of the host vehicle 2 with a magnitude of substantially 0.

In S60 illustrated in FIG. 4, the driving control block 140 determines whether or not the pre-control period Pap in the current driving assistance flow has been completed. As a result, when a negative determination is made during the pre-control period Pap, the next control cycle is started by returning the current driving assistance flow to S50. On the other hand, when an affirmative determination is made due to the completion of the pre-control period Pap, the next control cycle is started by returning the current driving assistance flow to S30. As described above, in the pre-control period Pap, the braking force Fb is controlled at an appropriate timing and to an appropriate value necessary for turning control to the avoidance direction Da for each wheel 20. That is, in the pre-control period Pap, by the yawing of the host vehicle 2 following the control command of S50, the actual yaw angle of the host vehicle 2 as illustrated in FIG. 5 is optimized for the avoidance direction Da toward collision avoidance. Depending on collision avoidance action by at least one of the brake operation and the steering operation of the driver, for example, when TTC increases to exceed the pre-threshold time or more, the current driving assistance flow may be terminated also in S60, and normal control of the driving task may be executed for the host vehicle 2 until the pre-avoidance condition is satisfied next.

In S30 illustrated in FIG. 4, when an affirmative determination is made due to satisfaction of the collision avoidance condition, the current driving assistance flow sequentially transitions to S70, S80, and S90. That is, the sequential transition from S30 to S70, S80, and S90 is realized in response to the collision risk with the object 3 in the host vehicle 2 subjected to turning control (yawing control) to the avoidance direction Da by the control command in the pre-control period Pap reaching the collision avoidance range.

In S70, the trajectory generation block 120 plans a driving trajectory Td to be a tracing target of the host vehicle 2 over an emergency control period Pae after satisfaction of the collision avoidance condition within the avoidance control period Pa illustrated in FIG. 5, toward collision avoidance with the object 3 in the future driving of the host vehicle 2. At this time, the driving trajectory Td is planned so as to define a time-series change in the required yaw rate Y_c as shown in FIG. 5 for each control cycle, in addition to a trajectory defined by time-series position coordinates, as a motion parameter to be a target in the future driving of the host vehicle 2.

In S80 illustrated in FIG. 4, the driving control block 140 generates a control command to the actuator system 4 based on the driving trajectory Td planned by S70 toward collision avoidance of the host vehicle 2. At this time, the control command is generated so as to perform coordinated control of the braking force Fb and the steering angle θs to be applied to each wheel 20 of the host vehicle 2 as illustrated in FIG. 5 in accordance with each motion parameter represented by the driving trajectory Td. Here, the coordinated control means a concept of controlling the braking force Fb and the steering angle θs in cooperation with each other, and, as a result of the coordination, the concept is also understood to include a control state in which one of them is controlled to a substantially zero value while the other is variably adjusted. The sign of the steering angle θs in FIG. 5 is defined such that the counterclockwise direction around the yaw axis from the longitudinal axis in the host vehicle 2 in a top view is positive and the clockwise direction is negative in accordance with the required yaw rate Y_c, however, the sign convention may also be defined with the opposite relationship.

Specifically, the control command in S80 controls the common steering angle θs of the front wheels 20fl, 20fr to a magnitude correlated with the required yaw rate Y_c in the left turning direction when the required yaw rate Y_c is positive as illustrated in a period Pael in FIG. 5 during the emergency control period Pae. The control command in S80 controls the common steering angle θs of the front wheels 20fl, 20fr to a magnitude correlated with the required yaw rate Y_c in the right turning direction when the required yaw rate Y_c is negative as illustrated in a period Paer in FIG. 5 during the emergency control period Pae.

In any of such periods Pael, Paer, the control command in S80 may control the distribution of the common steering angle θs between the front and rear by correlating the common steering angle θs of the rear wheels 20rl, 20rr with the required yaw rate Y_c in a case where the common steering angle θs of the rear wheels 20rl, 20rr is independently adjustable with respect to the common steering angle θs of the front wheels 20fl, 20fr. Furthermore, in any of the periods Pael, Paer, the control command in S80 may control the braking force Fb to be applied to the front wheels 20fl, 20fr and the braking force Fb to be applied to the rear wheels 20rl, 20rr to a left-right distribution correlating to the required yaw rate Y_c as illustrated in FIG. 5. Here, FIG. 5 illustrates the left braking force Fb in the period Pael, and omits illustration regarding the right braking force Fb in the period Paer. As a modification of FIG. 5, a control command may be generated so as to generate a necessary amount of left braking force Fb in the period Paer and/or generate a necessary amount of right braking force Fb in the period Pael. In addition to the above, in any of the periods Pael, Paer, the control command in S80 may correct each common steering angle θs and each braking force Fb within the range of the above-described control requirements based on the operation data from the operation determination block 100 when the driver is in an override state due to a manual driving operation with respect to the host vehicle 2.

It is preferable that such a control command in S80 is generated such that left and right maximum lateral movement amounts δL appearing in the host vehicle 2 as illustrated in FIG. 5 are equalized between the left and right over the avoidance control period Pa, which continuously follows the control command in S50. That is, it is preferable that averaging control for averaging the left and right maximum lateral movement amounts δL through the combined turning control and emergency control is executed in the avoidance control period Pa from the start of the turning control in the pre-control period Pap to the end of the coordinated control in the emergency control period Pae. That is, the averaging control of the maximum lateral movement amounts δL means controlling the maximum width of the left lateral movement amount by the left turn and the maximum width of the right lateral movement amount by the right turn to be substantially the same width in the host vehicle 2. The sign of the lateral movement amount including the maximum lateral movement amount δL in FIG. 5 is defined such that the left lateral movement amount is positive and the right lateral movement amount is negative, however, an inverse relationship definition is also acceptable. The maximum lateral movement amount may be referred to as a maximum lateral displacement.

In S90 illustrated in FIG. 4, the driving control block 140 determines whether or not the emergency control period Pae in the current driving assistance flow has been completed. As a result, when a negative determination is made during the emergency control period Pae, the next control cycle is started by returning the current driving assistance flow to S80. On the other hand, when an affirmative determination is made due to the completion of the emergency control period Pae, the current driving assistance flow ends. As described above, in the emergency control period Pae, the steering angle θs is controlled at an appropriate timing and to an appropriate value necessary for coordinated control together with the braking force Fb as necessary for each wheel 20. That is, also in the emergency control period Pae continuing from the pre-control period Pap, the yawing of the host vehicle 2 follows the control command of S80, so that the actual yaw angle of the host vehicle 2 as illustrated in FIG. 5 is optimized for collision avoidance. By ending the current driving assistance flow in such S90 and S10 described above, normal control of the driving task may be executed for the host vehicle 2 until the next pre-avoidance condition is satisfied.

### Effects

The effects of the first embodiment described above will be described below.

According to the first embodiment, turning control of the host vehicle 2 is performed in the avoidance direction Da toward collision avoidance before the collision risk of the host vehicle 2 with the object 3 rises to the collision avoidance range requiring collision avoidance for the host vehicle 2. As a result, in response to the collision risk reaching the collision avoidance range in the host vehicle 2 controlled to turn in the avoidance direction Da, the braking force Fb and the steering angle θs applied to the wheels 20 from the actuator system 4 are controlled in a coordinated manner in accordance with the driving trajectory Td planned for the host vehicle 2 toward collision avoidance. With this configuration, even if a response delay of the braking force Fb and/or the steering angle θs occurs in the actuator system 4, insufficient lateral displacement of the host vehicle 2 can be resolved by the turning control being executed during a period with a lower risk than the collision avoidance range. Therefore, it is possible to cause the host vehicle 2 to accurately trace the driving trajectory Td and secure a margin for collision avoidance from the viewpoint of safety and security, thereby making it possible to realize driving assistance effective for collision avoidance with the object 3 in the host vehicle 2.

According to the first embodiment, in response to the collision risk reaching the pre-avoidance range lower than the collision avoidance range, the host vehicle 2 is controlled to turn in the avoidance direction Da. With this configuration, even if a response delay of the braking force Fb and/or the steering angle θs occurs in the actuator system 4, the turning control is executed at an appropriate time when the collision risk is the pre-avoidance range lower than the collision avoidance range, thereby appropriately resolving insufficient lateral displacement of the host vehicle 2 during coordinated control. Therefore, it is possible to cause the host vehicle 2 to trace the driving trajectory Td with high precision and ensure a margin for collision avoidance, thereby making it possible to realize highly reliable driving assistance for collision avoidance with the object 3 in the host vehicle 2.

According to the first embodiment, the host vehicle 2 is controlled to turn in the avoidance direction Da by the left-right distribution of the braking force Fb applied to the wheels 20 from the braking actuator 44 in the host vehicle 2. As a result, in the host vehicle 2 controlled to turn in the avoidance direction Da, the steering angle θs applied to the wheels 20 from the steering actuator 42 and the braking force Fb from the braking actuator 44 are controlled in a coordinated manner in accordance with the driving trajectory Td. With this configuration, even if a response delay of the braking force Fb in the braking actuator 44 and/or a response delay of the steering angle θs in the steering actuator 42 occurs, the lateral movement amount can be gained by executing the turning control utilizing the left-right distribution of the braking force Fb while the risk is low. Therefore, it is possible to secure a margin for collision avoidance while substantially maintaining the steering angle θs and the steering operation angle determining it, so that it is possible to realize driving assistance effective for collision avoidance with the object 3 in the host vehicle 2 and particularly to realize assistance that is reassuring for the driver.

In the turning control and the coordinated control according to the first embodiment, averaging control that averages the maximum lateral movement amount δL appearing in the host vehicle 2 between the left and right of the host vehicle 2 is executed in the avoidance control period Pa from the start of the turning control to the end of the coordinated control. With this configuration, behaviors targeted respectively by the turn to the avoidance direction Da and the subsequent coordination of the braking force Fb and the steering angle θs can be stably realized on both the left and right of the host vehicle 2. Therefore, it is possible to realize vehicle behavior that is reassuring to the driver by driving assistance effective for collision avoidance with the object 3 in the host vehicle 2.

The turning control and the coordinated control according to the first embodiment may be executed in a driver override state with respect to the host vehicle 2. In this case, even during the driver override, behaviors targeted respectively by the turn to the avoidance direction Da and the subsequent coordination of the braking force Fb and the steering angle θs can be realized in the host vehicle 2. Therefore, it is possible to realize driving assistance effective for collision avoidance with the object 3 even in the host vehicle 2 where a manual driving operation of the driver is assumed.

### Second Embodiment

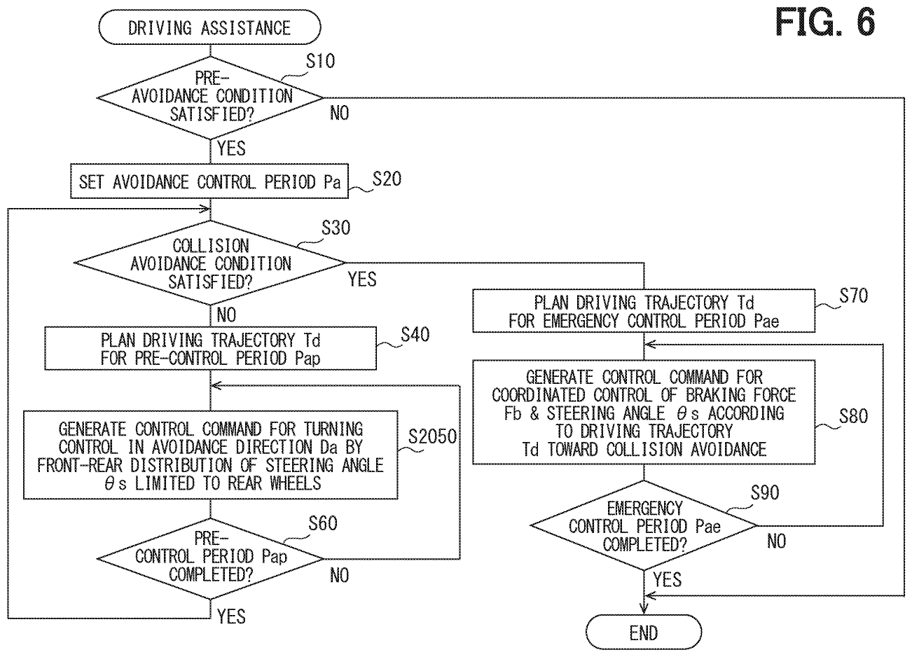

A second embodiment is a modification of the first embodiment. As illustrated in FIG. 6, in a driving assistance flow of the second embodiment, S2050 is executed in place of S50. For this purpose, in the second embodiment, the steering actuator 42 adjusts both the common steering angle θs of the front wheels 20fl, 20fr and the common steering angle θs of the rear wheels 20rl, 20rr. Thereby, in the second embodiment, the front-rear distribution of the common steering angle θs of the front wheels 20fl, 20fr and the common steering angle θs of the rear wheels 20rl, 20rr can be controlled.

Specifically, in S2050, the driving control block 140 of the second embodiment generates a control command to the steering actuator 42 to control the attitude of the host vehicle 2 toward the avoidance direction Da by adjusting the front-rear distribution of the steering angle θs applied to each wheel 20 of the host vehicle 2. At this time, the control command controlling the front-rear distribution of the common steering angle θs of the front wheels 20fl, 20fr and the common steering angle θs of the rear wheels 20rl, 20rr enables the host vehicle 2 to turn with a slight actual yaw rate by limiting application of the steering angle θs corresponding to the avoidance direction Da to the rear wheels 20rl, 20rr.

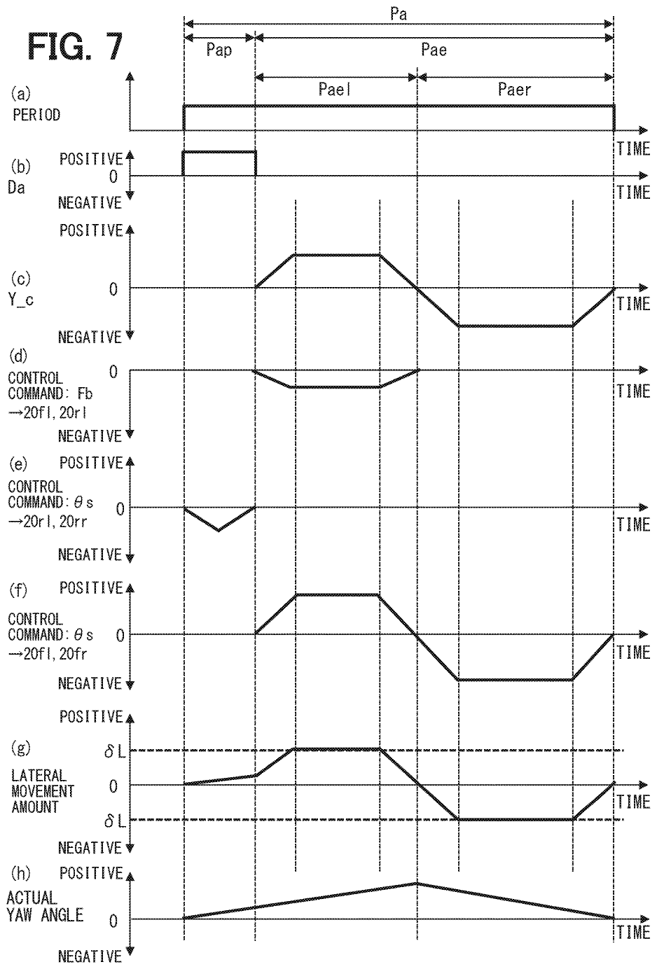

As illustrated in the pre-control period Pap of FIG. 7, when the avoidance direction Da is the left turning direction, a control command is generated so as to apply the common steering angle θs in the clockwise direction where the sign is negative to the rear wheels 20rl, 20rr with a magnitude that keeps a difference between the required yaw rate Y_c of substantially 0 and the actual yaw rate produced by the control command within a very small allowable range. At this time, when the driver is in an override state due to a manual driving operation with respect to the host vehicle 2, the common steering angle θs of the rear wheels 20rl, 20rr may be corrected within a range of such an allowable range difference based on the operation data from the operation determination block 100. Furthermore, when the avoidance direction Da is the left turning direction, a control command is generated so as to apply the common steering angle θs of substantially 0 to the front wheels 20fl, 20fr.

In a case where the avoidance direction Da is the right turning direction, a control command is generated as in the case where the avoidance direction Da is the left turning direction so as to apply the common steering angle θs in the counterclockwise direction where the sign is positive to the rear wheels 20rl, 20rr with a magnitude that keeps a difference between the required yaw rate Y_c of substantially 0 and the actual yaw rate produced by the control command within a very small allowable range. At this time, when the driver is in an override state due to a manual driving operation with respect to the host vehicle 2, the common steering angle θs of the rear wheels 20rl, 20rr may be corrected within a range of such an allowable range difference based on the operation data from the operation determination block 100. Furthermore, when the avoidance direction Da is the right turning direction, a control command is generated so as to apply the common steering angle θs of substantially 0 to the front wheels 20fl, 20fr as in the case of the left turning direction.

### Effects

The effects peculiar to the second embodiment described above will be described below.

According to the second embodiment, turning control of the host vehicle 2 is performed in the avoidance direction Da by the front-rear distribution of the steering angle θs applied to the wheels 20 from the steering actuator 42. As a result, in the host vehicle 2 controlled to turn in the avoidance direction Da, the braking force Fb applied to the wheels 20 from the braking actuator 44 and the steering angle θs from the steering actuator 42 are controlled in a coordinated manner in accordance with the driving trajectory Td. With this configuration, even if the steering actuator 42 exhibits a response delay in steering angle θs and/or the braking actuator 44 exhibits a response delay in braking force Fb, turning control utilizing the front-rear distribution of the steering angle θs can be executed quickly at a low-risk timing, thereby resolving insufficient lateral movement of the host vehicle 2 during coordinated control. Therefore, it is possible to cause the host vehicle 2 to trace the driving trajectory Td with high precision and secure a margin for collision avoidance, thereby making it possible to realize highly reliable driving assistance for collision avoidance with the object 3 in the host vehicle 2.

According to the second embodiment, the host vehicle 2 is controlled to turn in the avoidance direction Da by applying the steering angle θs corresponding to the avoidance direction Da only to the rear wheels 20rl, 20rr in the host vehicle 2. With this configuration, even if a response delay of the steering angle θs in the steering actuator 42 and/or a response delay of the braking force Fb in the braking actuator 44 occurs, the turning control concentrating the front-rear distribution of the steering angle θs on the rear wheels 20rl, 20rr is executed while the risk is low, whereby the lateral movement amount can be gained. Here, in particular, since the turn by the rear wheels 20rl, 20rr can increase the lateral movement amount as much as possible even with a small steering angle θs, it is possible to realize driving assistance effective for collision avoidance with the object 3 in the host vehicle 2 and particularly to realize assistance that is reassuring for the driver. Furthermore, in the host vehicle 2 having a configuration capable of disconnecting interlocking between the rear wheels 20rl, 20rr and the steering operation angle that determines the steering angle θs of the front wheels 20fl, 20fr, the margin for collision avoidance can be secured while substantially maintaining the steering operation angle, so that it is possible to realize driving assistance that is reassuring for the driver.

### Third Embodiment

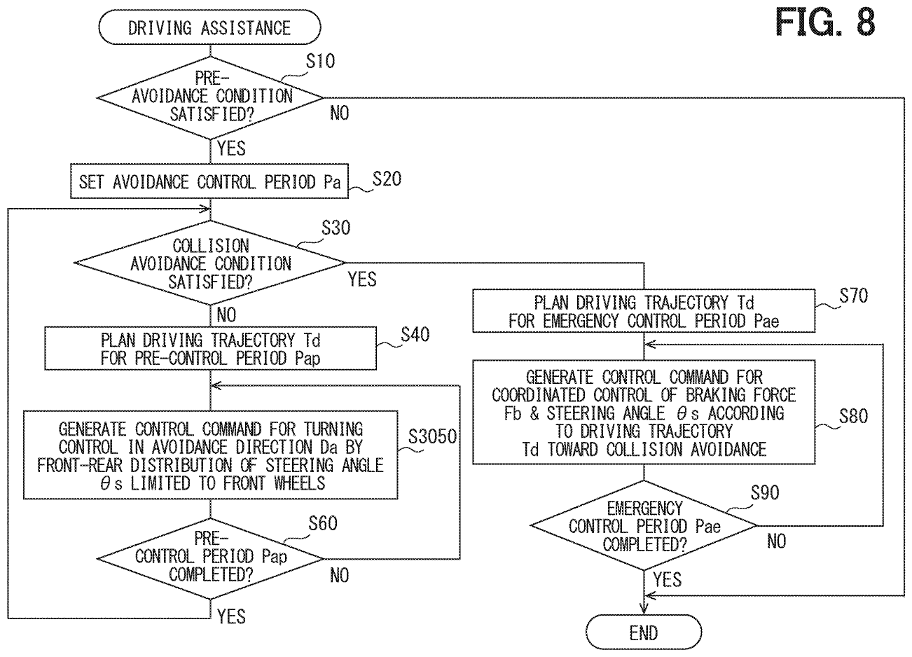

A third embodiment is a modification of the second embodiment. As illustrated in FIG. 8, in a driving assistance flow of the third embodiment, S3050 is executed in place of S2050. For this purpose, in the third embodiment, the steering actuator 42 adjusts at least one of the common steering angle θs of the front wheels 20fl, 20fr and the common steering angle θs of the rear wheels 20rl, 20rr as in the first embodiment.

Specifically, in S3050, the driving control block 140 of the third embodiment generates, for the braking actuator 44, a control command for controlling the attitude of the host vehicle 2 toward the avoidance direction Da by adjusting the front-rear distribution of the steering angle θs to be applied to each wheel 20 of the host vehicle 2. At this time, the control command controlling the front-rear distribution of the common steering angle θs of the front wheels 20fl, 20fr and the common steering angle θs of the rear wheels 20rl, 20rr enables the host vehicle 2 to turn with a slight actual yaw rate by limiting distribution of the steering angle θs corresponding to the avoidance direction Da to the front wheels 20fl, 20fr. Even in the host vehicle 2 having a configuration without an adjustment mechanism for the common steering angle θs of the rear wheels 20rl, 20rr, it can be deemed equivalent to generating a control command in which the distribution of the steering angle θs to the rear wheels 20rl, 20rr is structurally fixed at 0.

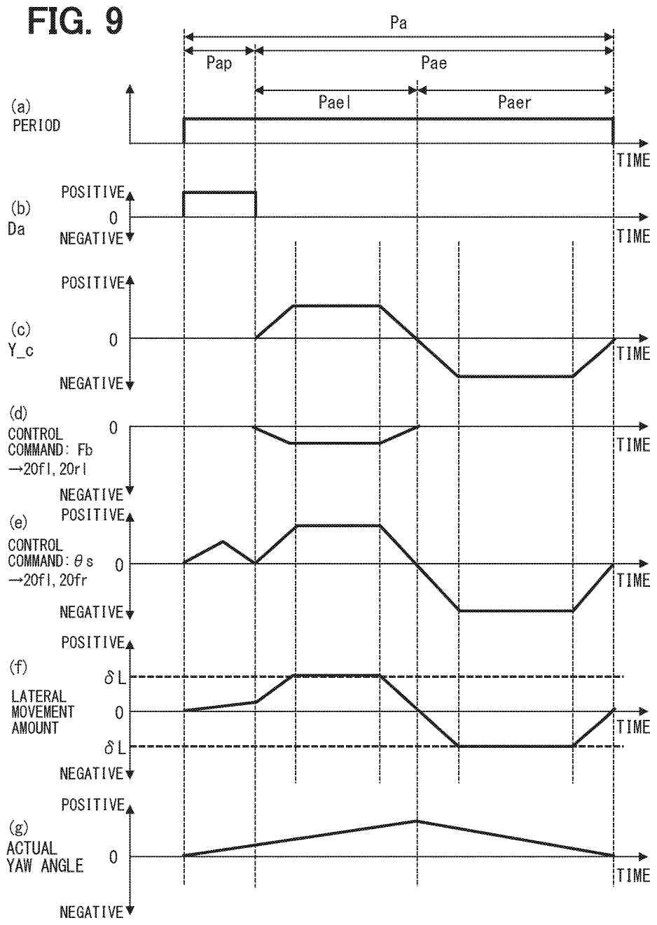

As illustrated in the pre-control period Pap of FIG. 9, when the avoidance direction Da is the left turning direction, a control command is generated so as to apply a positive (counterclockwise) common steering angle θs to the front wheels 20fl, 20fr with a magnitude that keeps a difference between the required yaw rate Y_c of substantially 0 and the actual yaw rate produced by the control command within a very small allowable range. At this time, when the driver is in an override state due to a manual driving operation with respect to the host vehicle 2, the common steering angle θs of the front wheels 20fl, 20fr may be corrected within a range of such an allowable range difference based on the operation data from the operation determination block 100. Furthermore, when the avoidance direction Da is the left turning direction, a control command is generated so as to apply the common steering angle θs of substantially 0 to the rear wheels 20rl, 20rr.

In a case where the avoidance direction Da is the right turning direction, a control command is generated as in the case where the avoidance direction Da is the left turning direction so as to apply the common steering angle θs in the clockwise direction where the sign is negative to the front wheels 20fl, 20fr with a magnitude that keeps a difference between the required yaw rate Y_c of substantially 0 and the actual yaw rate produced by the control command within a very small allowable range. At this time, when the driver is in an override state due to a manual driving operation with respect to the host vehicle 2, the common steering angle θs of the front wheels 20fl, 20fr may be corrected within a range of such an allowable range difference based on the operation data from the operation determination block 100. Furthermore, when the avoidance direction Da is the right turning direction, a control command is generated so as to apply the common steering angle θs of substantially 0 to the rear wheels 20rl, 20rr as in the case of the left turning direction.

### Effects

The effects specific to the third embodiment described above will be described below.

According to the third embodiment, the host vehicle 2 is controlled to turn in the avoidance direction Da by applying the steering angle θs corresponding to the avoidance direction Da only to the front wheels 20fl, 20fr in the host vehicle 2. With this configuration, even if a response delay of the steering angle θs in the steering actuator 42 and/or a response delay of the braking force Fb in the braking actuator 44 occurs, the turning control concentrating the front-rear distribution of the steering angle θs on the front wheels 20fl, 20fr is quickly executed while the risk remains low, thereby securing lateral displacement in advance. Therefore, it is possible to cause the host vehicle 2 to trace the driving trajectory Td with high precision and secure a margin for collision avoidance, thereby making it possible to realize highly reliable driving assistance that enables the host vehicle 2 to avoid a collision with the object 3.

### Other Embodiments

Although a plurality of embodiments have been described above, the present disclosure is not construed as being limited to those embodiments, and can be applied to various embodiments and combinations within a scope not departing from the gist of the present disclosure.

In a modification, the dedicated computer constituting the driving assistance system 1 may have at least one of a digital circuit and an analog circuit as a processor. Here, the digital circuit is at least one of, for example, an ASIC (Application Specific Integrated Circuit), an FPGA (Field Programmable Gate Array), an SoC (System on a Chip), a PGA (Programmable Gate Array), and a CPLD (Complex Programmable Logic Device). Such a digital circuit may have a memory storing a program.

In a modification, the operator performing a manual driving operation of the host vehicle 2 to which the driving assistance system 1 is applied may be a remote operator who remotely operates the driving of the host vehicle 2 from an external center. In a modification, the driving assistance system 1 may be configured to be realizable only for the automated driving task without the presence of the manual driving assistance task for assisting the manual driving operation of the operator. In the pre-control period Pap of a modification, the control command generation described in at least two of the first to third embodiments may be executed in combination.

What is claimed is:

1. A driving assistance system for assisting collision avoidance with an object during driving of a host vehicle, the driving assistance system comprising
a processor configured to execute:
turning control of the host vehicle toward an avoidance direction for the collision avoidance before a collision risk between the host vehicle and the object increases to a collision avoidance range at which collision avoidance is required; and
in response to the collision risk reaching the collision avoidance range in the host vehicle that has been subjected to turning control toward the avoidance direction, coordinated control of a braking force and a steering angle applied to wheels by an actuator system including a braking actuator and a steering actuator, in accordance with a driving trajectory planned for the host vehicle for the collision avoidance,
wherein
the turning control of the host vehicle includes turning control of the host vehicle toward the avoidance direction by limiting control to a left-right distribution of the braking force applied from the braking actuator to the wheels in the host vehicle, and
the coordinated control of the host vehicle includes coordinated control of the steering angle applied from the steering actuator to the wheels in the host vehicle and the braking force.

2. The driving assistance system according to claim 1, wherein
the turning control of the host vehicle includes turning control of the host vehicle toward the avoidance direction in response to the collision risk reaching a pre-avoidance range, which is lower than the collision avoidance range.

3. The driving assistance system according to claim 1, wherein
the turning control and the coordinated control of the host vehicle include performing averaging control that averages, between left and right of the host vehicle, a maximum lateral movement amount occurring in the host vehicle during an avoidance control period from a start of the turning control to an end of the coordinated control.

4. A non-transitory computer readable storage medium storing a driving assistance program for assisting, during driving of a host vehicle, collision avoidance with an object, the driving assistance program including instructions for causing a processor to execute:
turning control of the host vehicle toward an avoidance direction for the collision avoidance before a collision risk between the host vehicle and the object increases to a collision avoidance range at which collision avoidance is required; and
in response to the collision risk reaching the collision avoidance range in the host vehicle that has been subjected to turning control toward the avoidance direction, coordinated control of a braking force and a steering angle applied to wheels by an actuator system, in accordance with a driving trajectory planned for the host vehicle for the collision avoidance,
wherein
the turning control of the host vehicle includes turning control of the host vehicle toward the avoidance direction by limiting control to a left-right distribution of the braking force applied from a braking actuator to the wheels in the host vehicle, and
the coordinated control of the host vehicle includes coordinated control of the steering angle applied from a steering actuator to the wheels in the host vehicle and the braking force.

5. A driving assistance method executed by a processor to assist, during driving of a host vehicle, collision avoidance with an object, the driving assistance method comprising:
turning control of the host vehicle toward an avoidance direction for the collision avoidance before a collision risk between the host vehicle and the object increases to a collision avoidance range at which collision avoidance is required; and
in response to the collision risk reaching the collision avoidance range in the host vehicle that has been subjected to turning control toward the avoidance direction, coordinated control of a braking force and a steering angle applied to wheels by an actuator system, in accordance with a driving trajectory planned for the host vehicle for the collision avoidance,
wherein
the turning control of the host vehicle includes turning control of the host vehicle toward the avoidance direction by limiting control to a left-right distribution of the braking force applied from a braking actuator to the wheels in the host vehicle, and
the coordinated control of the host vehicle includes coordinated control of the steering angle applied from a steering actuator to the wheels in the host vehicle and the braking force.
